(19) United States
(12) Patent Application Publication
(10) Pub. No.: US 2014/0262742 A1
(43) Pub. Date: Sep. 18, 2014

(54) Substrate for Increased Efficiency of Semiconductor Photocatalysts

(71) Applicant: Sunpower Technologies LLC, (US)

(72) Inventor: Travis Jennings, San Diego, CA (US)

(73) Assignee: Sunpower Technologies LLC, San Marcos, CA (US)

(21) Appl. No.: 13/797,428

(22) Filed: Mar. 12, 2013

(51) Int. Cl. B01J 19/12

(52) U.S. Cl. CPC B01J 19/122
USPC 204/157.15; 422/310; 422/186; 422/162

(57) ABSTRACT

A high surface area grid having two mesh sheets aligned in opposite direction to each other is disclosed. One mesh sheet may be horizontally aligned while the other may be vertically aligned. Piezoelectric actuators may be attached along the sides of each wire sheet, employing piezoelectric actuators to allow a precise control of the displacement of the wires. High surface area grid may be employed in the formation of a photoactive material, where semiconductor photocatalysts may be deposited onto high surface area grid. Photoactive material may be employed for a plurality of photocatalytic energy conversion applications such as water splitting and carbon dioxide reduction. Employing a high surface area grid with the capability of dynamically-controlled dimensions may increase efficiency of semiconductor photocatalysts on its surface.

### CROSS-REFERENCE TO RELATED APPLICATIONS

The disclosure here described is related to the invention disclosed in the U.S. application Ser. No. (not yet assigned), entitled “Oriented photocatalytic semiconductor surfaces” and U.S. application Ser. No. (not yet assigned), entitled “System for harvesting oriented light-CO₂ reduction”.

### BACKGROUND

1. Technical Field

The present disclosure relates in general to photocatalysis, and more particularly, to a high surface area grid employed in energy conversion applications.

2. Background Information

Photocatalytic processes may allow the conversion of pollutants into harmless substances directly in the contaminant source. In a photocatalytic system, photo-induced molecular transformation takes place at the catalyst surface. When a photocatalyst is illuminated by light stronger than its band gap energy (hvEg), the photocatalyst generates electron/hole pairs with free electrons (e⁻) produced in the empty conduction band leaving positive holes (h⁺) in the valence band. Electron-hole pairs diffuse out to the surface of photocatalysts, initiating a series of chemical reactions leading to energy conversion.

The production of photoactive materials for photocatalytic processes, such as water splitting and carbon dioxide reduction, involves depositing photocatalytic semiconductors on a suitable planar substrate. Substrates may be composed of metal oxides, silver halides, graphene oxide, among others. These substrates may not provide enough surface area for redox reactions to take place at higher efficiencies.

There is still a need for improvement in this field, including the need for development of improved materials and devices that may operate with higher energy conversion efficiency for alternative fuel generation.

### SUMMARY

According to various embodiments of the present disclosure, a high surface area grid having two separate mesh sheets aligned in opposite directions to each other is disclosed. The high surface area grid may have a precise control over spacing and contact dimensions between neighboring wires. Suitable materials for mesh sheets may include metal oxides such as titanium dioxide, silver halides, graphene oxide, metallic materials such as aluminum alloys, stainless steel, among others.

High surface area grid may include two wire grids, where one wire grid may be vertically aligned and the other horizontally aligned. Two piezoelectric actuators may be attached to the sides of each wire grid. Piezoelectric actuators may be employed to control displacement of one wire from the others.

According to various embodiments, high surface area grid may be employed in substrates for photocatalytic processes such as water splitting and carbon dioxide reduction. When employed in water splitting processes, high surface area grid may increase of light harvesting efficiency, employing of semiconductor photocatalysts, by increasing surface area available for interaction with the water bath, and refreshing static volumes of water in direct contact with the surface of the substrate.

In one embodiment, a substrate for increased efficiency of semiconductor photocatalysts comprises a first set of substantially parallel wires extending in a first direction; a first piezoelectric actuator coupled to the first set of wires at a first end of the first set of wires; a second piezoelectric actuator coupled to the first set of wires at a second end of the first set of wires; a second set of substantially parallel wires extending in a second direction that is perpendicular to the first direction, wherein the first and second set of wires form a high surface area grid; a third piezoelectric actuator coupled to the second set of wires at a first end of the second set of wires; and a fourth piezoelectric actuator coupled to the second set of wires at a second end of the second set of wires.

In another embodiment, a photocatalytic system comprises a first set of substantially parallel wires extending in a first direction; a first piezoelectric actuator coupled to the first set of wires at a first end of the first set of wires; a second piezoelectric actuator coupled to the first set of wires at a second end of the first set of wires; a second set of substantially parallel wires extending in a second direction that is perpendicular to the first direction, wherein the first and second set of wires form a high surface area grid; a third piezoelectric actuator coupled to the second set of wires at a first end of the second set of wires; a fourth piezoelectric actuator coupled to the second set of wires at a second end of the second set of wires; a plurality of semiconductor nanocrystals deposited on the high surface area grid; and a reaction vessel housing the high surface area grid, wherein the reaction vessel comprises a transparent material so that light from a light source enters the reaction vessel and make contact with the semiconductor nanocrystals to separate charge carriers from the semiconductor nanocrystals for use in a reaction.

In another embodiment, a method for controlling the surface area of a substrate comprises receiving light on the substrate; varying a distance between adjacent wires in a first set of substantially parallel wires and varying a distance between adjacent wires in a second set of substantially parallel wires that are perpendicular to the first set of wires, using piezoelectric actuators coupled to each end of the first and second set of wires and based on how much of the surface area of the substrate the light contacts.

Numerous other aspects, features and advantages of the present disclosure may be made apparent from the following detailed description, taken together with the drawing figures.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example with reference to the accompanying figures which are schematic and are not intended to be drawn to scale. Unless indicated as representing the background art, the figures represent aspects of the disclosure.

FIG. 1 depicts a mesh substrate employed for high surface area grid, according to an embodiment.

FIG. 2A illustrates vertically aligned wires connected to piezoelectric actuators and horizontally aligned wires connected to piezoelectric actuators, according to an exemplary embodiment. FIG. 2B illustrates a high surface area grid including vertically aligned wires superimposed over horizontally aligned wires, according to an exemplary embodiment.

FIG. 3 shows a photoactive material with the high surface area grid employed in a water splitting process, according to an embodiment.

### DETAILED DESCRIPTION

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or other changes may be made without departing from the spirit or scope of the present disclosure.

### DEFINITIONS

As used herein, the following terms may have the following definitions:

“High surface area grid” refers to a material having a mesh and two or more piezoelectric actuators. Such material may be employed as a substrate in photocatalytic processes.

“Piezoelectric actuator” refers to multilayer devices employed for nano and micro-positioning.

### DESCRIPTION OF DRAWINGS

FIG. 1 depicts mesh 100 employed in high surface area grid. Mesh 100 may include two superimposed sheets having wires aligned in opposite direction to each other, vertically aligned wires 102 and horizontally aligned wires 104. Suitable materials for vertically aligned wires 102 and horizontally aligned wires 104, may include titanium dioxide, silver halides, graphene oxide, metallic materials such as aluminum alloys, stainless steel, among others.

Mesh 100 size may vary according to the application, while distance between vertically aligned wires 102 and horizontally aligned wires 104 may range between about 10 nm and about 1 μm, where preferred distance may be between about 20 nm and about 50 nm. Diameter of the wires may be within a range of about 0.5 μm and about 10 μm.

FIG. 2 illustrates a high surface area grid 200. High surface area grid 200 may incorporate vertically aligned wires 102 and horizontally aligned wires 104 having piezoelectric actuators 202. Piezoelectric actuators 202 are employed in order to control the dimensions of mesh 100.

Piezoelectric actuators 202 may be connected to wires using epoxy adhesives. Depending on the dimensions of vertically aligned wires 102 and horizontally aligned wires 104 and the suitable displacement of one wire from another, more than one piezoelectric actuator 202 may be employed. Piezoelectric actuator 202 may be connected in series if there is more than one employed.

Suitable piezoelectric actuators 202 may include Noliac stacked multilayer piezoelectric actuators. Stacked multilayer piezoelectric actuators 202 may be made of two or several linear actuators glued together. The purpose of the stacking may be to obtain more displacement that can be achieved by a single linear actuator. Piezoelectric actuators 202 may have a length ranging from about 2 mm to about 15 mm, a width between about 2 mm and about 15 mm, and a height within a range of about 4 mm and about 15 mm. The relationship of current and voltage for a piezoelectric actuator 202 may be calculated employing the following equation:

I=dQ/dt=C×dU/dt (1)

where:

I=current

Q=charge

C=capacitance

U=voltage

t=time

According to an embodiment, suitable minimum voltage for piezoelectric actuators 202 may be of about 60 V. Depending on the application, piezoelectric actuators 202 may operate sinusoidally at a frequency from 0 Hz to about 100 Hz.

FIG. 2A shows vertically aligned wires 102 having two piezoelectric actuators 202 and horizontally aligned wires 104 with two piezoelectric actuators 202 attached along the sides. FIG. 2B depicts high surface area grid 200, where vertically aligned wires 102 and horizontally aligned wires 104 are superimposed, hence forming a grid.

Piezoelectric actuators 202 may allow a precise control of the displacement of the wires. Each wire may be individually controlled along the x, y and/or z axis, thus allowing wires and sheets to get closer or further apart from each other, or to move up and down from each other. The ability to manipulate the distance between vertically aligned wires 102 and horizontally aligned wires 104 may enable an increase in the surface area available for light harvesting.

FIG. 3 shows water splitting 300 process where high surface area grid 200 is employed as a substrate.

According to an embodiment, high surface area grid 200 may be employed in the production of photoactive materials 302 for photocatalytic processes such as water splitting 300. Suitable photocatalytic semiconductor nanocrystals may be deposited onto high surface area grids 200 in order to create a photoactive material 302. Photoactive material 302 may be submerged in water 304 within a reaction vessel 306. When light 308 from light source 310 makes contact with nanocrystals within photoactive material 302, redox reactions may take place in which a charge separation process may occur. This charge separation may result in electrons reducing hydrogen molecules 312 and oxygen molecules 314 being oxidized by holes.

According to various embodiments, one or more walls of reaction vessel 306 may be formed of glass or other transparent material, so that light 308 may enter reaction vessel 306. It is also possible that most or all of the walls of reaction vessel 306 may be transparent such that light 308 may enter from many directions. In another embodiment, reaction vessel 306 may have one transparent side to allow the incident radiation to enter and the other sides may have a reflective interior surface to reflect the majority of the solar radiation.

The ability to control the displacement of the wires within high surface area grid 200 may enable neighboring wires to come closer together. When direct light 308 is intense or is being focused to a small area with high photon flux, a high density of wires may be desired to harvest as much light 308 as possible. Separating the wires from neighboring wires may be required when direct light 308 is sufficient, and increasing the available surface area for photocatalytic reactions is favorable.

Piezoelectric actuators 202 may also enable the vibration of high surface area grid 200 at a suitable frequency. The vibration may agitate water 304 in contact with high surface area grid 200 which may renew water 304 as a resource during photocatalysis. The vibration may also help to dislodge any bubble formation occurring at the interface which may be blocking photocatalytic production.

In other embodiments, high surface area grid 200 may be employed as a substrate for the photocatalytic reduction of carbon dioxide, since distance between the wires may be suitable for gas flow.

It should be understood that the present disclosure is not limited in its application to the details of construction and arrangements of the components set forth here. The present disclosure is capable of other embodiments and of being practiced or carried out in various ways. Variations and modifications of the foregoing are within the scope of the present disclosure. It also being understood that the invention disclosed and defined here extends to all alternative combinations of two or more of the individual features mentioned or evident from the text and/or drawings. All of these different combinations constitute various alternative aspects of the present invention. The embodiments described here explain the best modes known for practicing the invention and will enable others skilled in the art to utilize the invention.

Thus the scope of the invention should be determined by the appended claims and their legal equivalents, and not by the examples given.

While various aspects and embodiments have been disclosed, other aspects and embodiments are contemplated. The various aspects and embodiments disclosed are for purposes of illustration and are not intended to be limiting, with the true scope and spirit being indicated by the following claims.

The embodiments described above are intended to be exemplary. One skilled in the art recognizes that numerous alternative components and embodiments that may be substituted for the particular examples described herein and still fall within the scope of the invention.

What's claimed is:

1. A substrate for increased efficiency of semiconductor photocatalysts comprising:
a first set of substantially parallel wires extending in a first direction;
a first piezoelectric actuator coupled to the first set of wires at a first end of the first set of wires;
a second piezoelectric actuator coupled to the first set of wires at a second end of the first set of wires;
a second set of substantially parallel wires extending in a second direction that is perpendicular to the first direction;
a third piezoelectric actuator coupled to the second set of wires at a first end of the second set of wires; and
a fourth piezoelectric actuator coupled to the second set of wires at a second end of the second set of wires.

2. The substrate for increased efficiency of semiconductor photocatalysts of claim 1, wherein the first and second set of wires include at least one selected from the group consisting of titanium dioxide, silver halides, graphene oxide, or a metallic material.

3. The substrate for increased efficiency of semiconductor photocatalysts of claim 1, wherein the diameter of each wire in the first and second set of wires is between 0.5 μm and 1.0 μm.

4. The substrate for increased efficiency of semiconductor photocatalysts of claim 1, wherein the first, second, third, and fourth piezoelectric actuators control the displacement of adjacent wires of the first and second set of wires and the distance between the first set of wires and the second set of wires.

5. The substrate for increased efficiency of semiconductor photocatalysts of claim 1, wherein each of the first, second, third, and fourth piezoelectric actuators connects to the first and second set of wires using epoxy adhesives.

6. The substrate for increased efficiency of semiconductor photocatalysts of claim 1, wherein each of the first, second, third, and fourth piezoelectric actuators is Noliac stacked multilayer piezoelectric actuators.

7. The substrate for increased efficiency of semiconductor photocatalysts of claim 1, wherein a distance between adjacent wires in the first and second set of wires ranges from 10 nm to 1.0 μm.

8. The substrate for increased efficiency of semiconductor photocatalysts of claim 1, wherein the first, second, third, and fourth piezoelectric actuators operate sinusoidally at a frequency ranging from 0 to 100 Hz.

9. The substrate for increased efficiency of semiconductor photocatalysts of claim 1, wherein each of the first, second, third, and fourth piezoelectric actuators has a minimum driving voltage of 60 V.

10. The substrate for increased efficiency of semiconductor photocatalysts of claim 1, wherein the first, second, third, and fourth piezoelectric actuators move the first and second set of wires up and down relative to each other.

11. The substrate for increased efficiency of semiconductor photocatalysts of claim 1, wherein the first and second set of wires and first, second, third, and fourth piezoelectric actuators form a high surface area grid.

12. The substrate for increased efficiency of semiconductor photocatalysts of claim 11, further comprising:
semiconductor nanocrystals deposited on the high surface area grid.

13. A photocatalytic system comprising:
a first set of substantially parallel wires extending in a first direction;
a first piezoelectric actuator coupled to the first set of wires at a first end of the first set of wires;
a second piezoelectric actuator coupled to the first set of wires at a second end of the first set of wires;
a second set of substantially parallel wires extending in a second direction that is perpendicular to the first direction;
a third piezoelectric actuator coupled to the second set of wires at a first end of the second set of wires;
a fourth piezoelectric actuator coupled to the second set of wires at a second end of the second set of wires,
wherein the first and second set of wires and the first, second, third, and fourth piezoelectric actuators form a high surface area grid;
a plurality of semiconductor nanocrystals deposited on the high surface area grid; and
a reaction vessel housing the high surface area grid, wherein the reaction vessel comprises a transparent material so that light from a light source enters the reaction vessel and make contact with the semiconductor nanocrystals to separate charge carriers from the semiconductor nanocrystals for use in a reaction.

14. The photocatalytic system of claim 13, wherein the reaction is water splitting.

15. The photocatalytic system of claim 13, wherein the reaction is carbon dioxide reduction.

16. The photocatalytic system of claim 13, wherein the first through fourth piezoelectric actuators increase the distance between adjacent wires in the first set of wires and adjacent wires in the second set of wires to increase the surface area of the high surface area grid when the light contacts a majority of the high surface area grid.

17. The photocatalytic system of claim 13, wherein the first through fourth piezoelectric actuators decrease the distance between adjacent wires in the first set of wires and adjacent wires in the second set of wires to decrease the surface area of the high surface area grid when the light is intense or focused on a small area with high photon flux.

18. A method for controlling the surface area of a substrate comprising:
receiving light on the substrate;
varying a distance between adjacent wires in a first set of substantially parallel wires and varying a distance between adjacent wires in a second set of substantially parallel wires that are perpendicular to the first set of wires, using piezoelectric actuators coupled to each end of the first and second set of wires and based on how much of the surface area of the substrate the light contacts.

19. The method of claim 18, further comprising
vibrating the first and second set of wires using the piezoelectric actuators.

20. The method of claim 18, wherein the piezoelectric actuators decrease the distance between adjacent wires in the first set of wires and adjacent wires in the second set of wires to decrease the surface area of the substrate when the light is intense or focused on a small area with high photon flux.

21. The method of claim 18, wherein the piezoelectric actuators increase the distance between adjacent wires in the first set of wires and adjacent wires in the second set of wires to increase the surface area of the substrate when the light contacts a majority of the substrate's surface area.
